(19) United States
(12) Patent Application Publication
(10) Pub. No.: US 2006/0190765 A1
(43) Pub. Date: Aug. 24, 2006

(54) Method and system for correcting errors in read-only memory devices, and computer program product therefor

(75) Inventors: Nicolas Bernard Grossier, Oreno di Vimercate (IT); Chilakala Ravi Kumar, Uttar Pradesh (IN); Saverio Pezzini, Vimercate (IT)

Correspondence Address: SEED INTELLECTUAL PROPERTY LAW GROUP PLLC, 701 FIFTH AVENUE, SUITE 6300, SEATTLE, WA, 98104-7092, US

(73) Assignee: STMicroelectronics S.r.l., Agrate Brianza (IT)

(21) Appl. No.: 11/344,538

(22) Filed: Jan. 30, 2006

(30) Foreign Application Priority Data
Jan. 31, 2005 (EP) 05001917.3

(51) Int. Cl. G06F 11/00

(52) U.S. Cl. 714/8

(57) ABSTRACT

A system for correcting errors in read-only memory devices by means of memory patches, wherein patch data is used as read data in the place of erroneous data stored at a given location in the memory. The system includes a processing core, such as an ARM processor, adapted to perform opcode accesses as well as data accesses to memory addresses being patched. The processing core is configured for providing different patch-data for correcting errors depending on whether it is performing a code access or a data access to an address being patched.

### BACKGROUND OF THE INVENTION

1. Field of the Invention

The invention relates to techniques for correcting errors in read-only memory devices.

2. Description of the Related Art

Most application codes of current use today are embedded in read-only memory devices like, e.g., Read Only Memory (ROM) devices, flash memory devices, and Electrically Erasable Programmable Read-Only Memory (EEPROM) devices. As used herein, “read-only memory” is any memory that cannot be written to (ROM), can be programmed only once (PROM), or can be written to only after an erase step (e.g., EPROM, EEPROM, flash).

Memory patches are widely used with read-only or non-volatile memories that require special procedures to be updated (e.g., flash). A memory patch is a readable/writable shadow unitary set of data (instruction or data with 16/32 bit) automatically selected in place of the original data when enabled. A memory patch is useful to correct late-found errors in application code (ROM correction), and to debug code located in a read-only memory device (ROM, flash, EEPROM) providing the possibility to set several breakpoints on a specific address.

Sometimes patches are needed to fix a defined problem, especially when the correction of a single instruction is not enough to solve the problem.

As shown in FIG. 1, a patch can be implemented by means of a comparator 10, a patch address memory 20, such as a register, that stores a patch address value, and a patch data memory 30, such as a register, that stores a patch data value. When an address 50 that contains an error and needs to be patched is accessed, the comparator 10 detects it by comparing the address 50 with the patch address value from the patch address memory 20. The patch data 30 is sent back, as a read data 60, in the place of the data stored at the location indicated by the address 50 in a memory 40.

In the case of a late-detected bug, it may be difficult to correct the code using only one patch address. For that purpose it is customary to use several patches or to “jump” to some patch-code function written in a volatile memory like Static Random Access Memory (SRAM), or Dynamic Random Access Memory (DRAM).

Jumping to a new address further than +/−32 Mbytes of the actual PC in ARM V4 processor architecture normally requires at least two instructions: a first instruction to load a register with the new PC address destination, and a BX instruction or LDR PC, [Rn] instruction to jump to the new PC address destination.

This requires to patch at least two instruction addresses in the memory space, and therefore use two memory patches: two comparators, two patch data registers, two patch address registers (or a patch address register and an “incrementer” to generate the value of the second patch address, which is the address immediately following the patch address register value).

### BRIEF SUMMARY OF THE INVENTION

While such prior art arrangements are capable of providing satisfactory results, the need is felt for an improved solution adapted to ensure a minimum amount of patches needed to correct an error in a code stored in a read-only memory device.

According to the present invention, that object is achieved by means of a method having the features set forth in the claims that follow. The invention also relates to a corresponding system as well as a related computer program product, loadable in the memory of at least one computer and including software code portions for performing the steps of the method of the invention when the product is run on a computer. As used herein, reference to such a computer program product is intended to be equivalent to reference to a computer-readable medium containing instructions for controlling a computer system to coordinate the performance of the method of the invention. Reference to “at least one computer” is evidently intended to highlight the possibility for the present invention to be implemented in a distributed/modular fashion.

The claims are an integral part of the disclosure of the invention provided herein.

A significant advantage of the arrangement described herein is that it allows to implement a long-jump in only one instruction.

Another advantage of the arrangement described herein is the possibility to use only one patch instead of two, and thus providing more available patches (or using less gate to implement equivalent functionality).

### BRIEF DESCRIPTION OF THE SEVERAL VIEWS OF THE DRAWINGS

The invention will now be described, by way of example only, with reference to the enclosed figures of drawing, wherein:

FIG. 1, related to the prior art, has already been described in the foregoing;

FIG. 2 is an exemplary representation of patch implementation according to the arrangement described herein; and

FIG. 3 shows an example of timing diagram explicative of the arrangement described herein.

### DETAILED DESCRIPTION OF THE INVENTION

It is possible to emphasize the fact that the arrangement described herein enables to implement a long-jump patch by patching only one instruction. The difficulty with patching memory is, in general, represented by the identification of the right instruction to be replaced to implement the patch. This becomes even more difficult when it is necessary to patch more than one instruction, for example in the case of long jump implementation.

An optimized code may have some branches entering the function at address n and branches entering the function at address n+1. If for some reason it is necessary to patch address n, then it is no more possible to use a long jump if more than one instruction is needed (for example “MOVE R0=new address MSB”, “ADD PC=R0<<16+new address LSB”) because branch at address n+1 would generates erroneous execution flow (in this case, a jump at address R0<<16+new address LSB, without the initialization of R0).

The arrangement described herein essentially implements a pseudo low-cost long-jump instruction using only one patch. This consequently reduces the number of patches used to correct an error in the code (or increases the number of available patches for error correction).

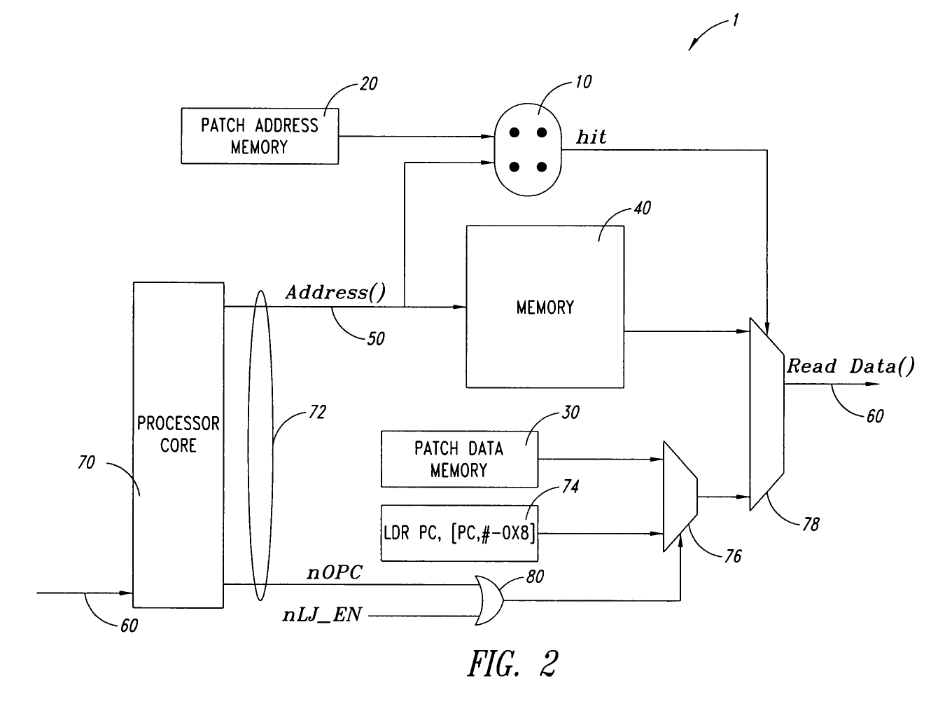

One embodiment of the invention is directed to a computer system 1 shown in FIG. 2. The computer system 1 includes the comparator 10, patch address memory 20, patch data memory 30, and memory 40, together with a processor core 70 coupled to the memory 40 by a bus 72, such as a native or advanced high-performance bus (AHB). The computer system 1 also includes a patch code memory 74, such as a register, that stores a fixed ARM opcode LDR PC, [PC, #-PCinc]. It will be appreciated that the patch address memory 20, patch data memory 30, and patch code memory 74 could be implemented with individual registers or by different locations of a memory device such as a RAM.

The patch data memory 30 and patch code memory 74 are coupled to respective inputs of a multiplexer 76 that selectively provides at output either the patch data value or the patch opcode LDR PC, [PC, #-PCinc]. The output of the multiplexer 76 is coupled to a first input of a multiplexer 78 having a second input coupled to the memory 40. The multiplexer 78 provides at output either read data from the memory 40 or the patch data or patch code from the multiplexer 76. The multiplexer 76 is controlled by a signal from an OR logic gate 80 having as inputs an nOPC signal and an enable signal nLJ_EN.

The arrangement described herein uses the nOPC signal, which is provided by the core of an ARM microprocessor and is available as a sideband signal on the Native or Advanced High-performance Bus (AHB) bus 72. This signal can be used to discriminate between code accesses and data accesses.

The use of an ARM7TDMI processor is only an example, and other types of processor can be utilized. In particular, in the solution described herein, in order to implement this kind of patches, a processor with the following characteristics can be employed:

the possibility to discriminate opcode memory access from data memory access (this is done by nOPC (or HPROT[1]) in the case of an ARM processor), and the possibility to implement an instruction for PC modification, which enables one to generate a PC update with a data read access at the same address as the code memory that has just been read (this is done by LDR PC, [PC-0x8] in the case of an ARM processor).

The underlying principle of the arrangement described herein is to provide different patch-data depending on whether the core is performing an opcode access or a data access to the patched address.

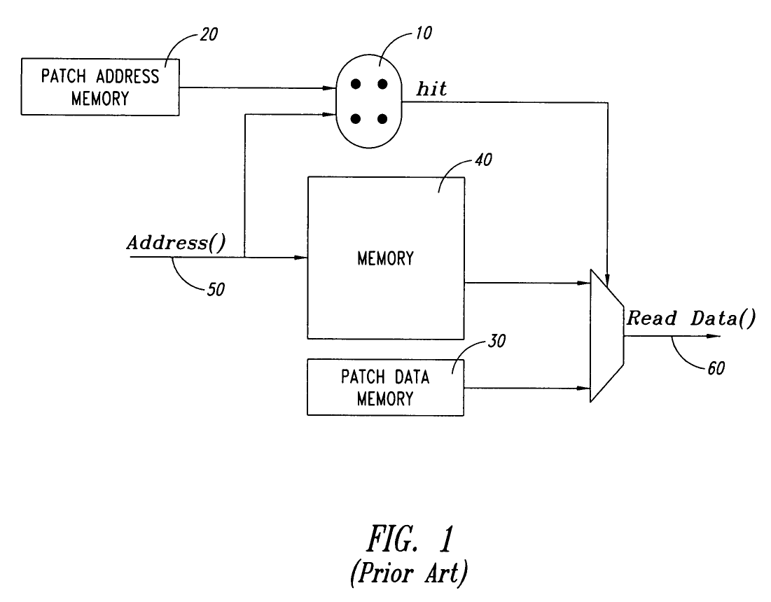

This principle is portrayed is shown in FIG. 2, wherein the blocks identical or equivalent to those already described in connection with FIG. 1 are designated with the same reference numbers used in the foregoing.

More specifically:

in the case of a code fetch, a fixed ARM opcode LDR PC, [PC, #-PCinc] is provided to the microprocessor core 70;

in the case of a data read, the new 32-bit PC destination is provided.

With this method, it is possible to perform a long jump, without having to deal with problems of address alignment for the comparator, while also saving some bits. In fact, the instruction is a fixed value, which does not need to be registered, and only the address is saved in the 32-bit patch-data register.

A further bit nLJ_EN enables the long-jump patch when needed, otherwise the patch can be used in a standard way.

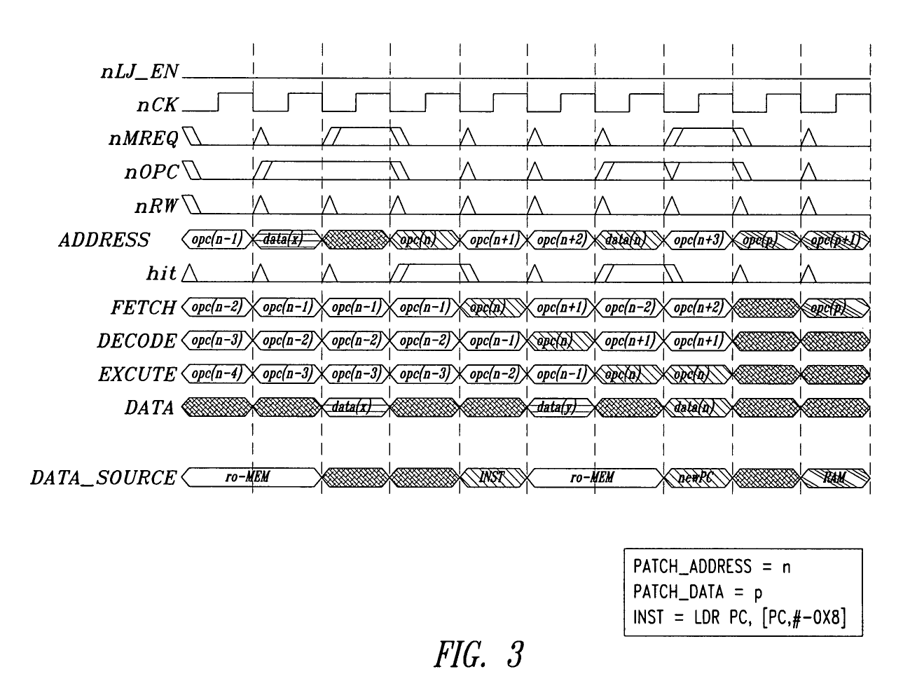

For example, FIG. 3 refers to the case of an ARM7TDMI microprocessor (3-stage pipeline, PCinc=0x8), and describes the status of the core pipeline (FETCH, DECODE, EXECUTE), the access done to the memory patch logic (CODE_ACCESS, DATA_ACCESS) and the status of the signals described in the foregoing.

Specifically, FIG. 3 shows the accesses to read-only memory, the accesses to the patch, the accesses to RAM containing patch code, and the accesses to RAM containing data accesses.

The opcode at the address n−3 is accessed to address x, whereas the opcode at the address n is the patch code which generate the load at n.

When the code arrives at the patched address n, the ‘LDR PC, [PC-0x8]’ instruction is fetched.

When this instruction reaches the EXECUTE stage of the ARM pipeline, it will load the content of address PC-0x8 which will be equal to the patched address (PC has incremented by 0x8 while the instruction was processed into the pipeline).

The PC is loaded with the new address to jump to and the core fetches the new instruction.

Without prejudice to the underlying principles of the invention, the details and the embodiments may vary, also appreciably, with reference to what has been described by way of example only, without departing from the scope of the invention as defined by the annexed claims.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

1. A method of correcting errors in a memory device using memory patches, wherein patch data is used as read data in the place of erroneous data stored at a given location in said memory, the method comprising the steps of:
providing a processing core structured to perform opcode accesses as well as data accesses to memory addresses being patched; and
providing different patch-data for correcting errors depending on whether said core is performing a code access or a data access to an address being patched.

2. The method of claim 1, wherein said processing core is an ARM processing core structured to be provided with a fixed ARM opcode, the method further comprising:
providing to said ARM processing core:
i) in the case of a code fetch, said fixed ARM opcode; and
ii) in the case of a data read, a new 32-bit PC destination.

3. The method of claim 1 wherein said processing core is a processing core structured to provide nOPC signals available as sideband signals on at least one bus, the method further comprising:
discriminating between code accesses and data accesses based on said nOPC signals.

4. The method of claim 1, further comprising performing a jump to a patch-code function written in a memory.

5. The method of claim 4, wherein the performing step includes selectively performing said jump to locate a long-jump patch.

6. The method of claim 1, wherein said processing core is a pipeline processing core wherein a load instruction reaches an execution stage in said pipeline, the method further comprising:
when code arrives at a patched address, fetching said load instruction;
when said load instruction reaches said execution stage in said pipeline, loading a content of an address equal to the patched address;
loading said processing core with a new address to jump to; and
causing said processing core to fetch a new instruction.

7. A computer system, comprising:
a memory device having a storage location that stores erroneous data; and
a processing core structured to perform opcode accesses as well as data accesses to memory addresses being patched, said processing core being configured for providing different patch-data for correcting errors depending on whether said core is performing a code access or a data access to an address of the memory device being patched.

8. The system of claim 7, wherein said processing core is an ARM processing core structured to be provided with a fixed ARM opcode, the system being configured for providing to said ARM processing core:
i) in the case of a code fetch, said fixed ARM opcode; and
ii) in the case of a data read, a new 32-bit PC destination.

9. The system of claim 7 wherein said processing core is a processing core structured to provide nOPC signals available as sideband signals on at least one bus, wherein code accesses and data accesses are discriminated based on said nOPC signals.

10. The system of claim 7 wherein said processing core is configured for performing a jump to a patch-code function written in a memory.

11. The system of claim 10, wherein said processing core is configured for selectively performing said jump to locate a long-jump patch.

12. The system of claim 7 wherein said processing core is a pipeline processing core wherein a load instruction reaches an execution stage in said pipeline, said processing core being configured for:
when code arrives at a patched address, fetching said load instruction,
when said load instruction reaches said execution stage in said pipeline, loading the content of the address equal to the patched address,
loading said processing core with a new address to jump to, and
fetching a new instruction.

13. A computer-readable medium including code portions that cause a computing device to correct errors in a memory device using memory patches, wherein patch data is used as read data in the place of erroneous data stored at a given location in said memory, by performing a method comprising:
performing, using a processing core, opcode accesses as well as data accesses to memory addresses being patched; and
providing different patch-data for correcting errors depending on whether said core is performing a code access or a data access to an address being patched.

14. The computer-readable medium of claim 13, wherein said processing core is an ARM processing core structured to be provided with a fixed ARM opcode LDR PC, the method further comprising:
providing to said ARM processing core:
i) in the case of a code fetch, said fixed ARM opcode LDR PC, and
ii) in the case of a data read, a new 32-bit PC destination.

15. The computer-readable medium of claim 13 wherein said processing core is a processing core structured to provide nOPC signals available as sideband signals on at least one bus, the method further comprising:
discriminating between code accesses and data accesses based on said nOPC signals.

16. The computer-readable medium of claim 13, wherein the method further comprises performing a jump to a patch-code function written in a memory.

17. The computer-readable medium of claim 16, wherein the performing step includes selectively performing said jump to locate a long-jump patch.

18. The computer-readable medium of claim 13, wherein said processing core is a pipeline processing core wherein a load instruction reaches an execution stage in said pipeline, the method further comprising:
when code arrives at a patched address, fetching said load instruction;
when said load instruction reaches said execution stage in said pipeline, loading a content of an address equal to the patched address;
loading said processing core with a new address to jump to; and
causing said processing core to fetch a new instruction.

19. A computer system, comprising:
a memory device having a storage location that stores erroneous data;
a patch data memory storing patch data;
a patch code memory store a patch code instruction;
a processor structured to perform opcode accesses as well as data accesses to memory addresses being patched; and
selection means for selectively providing to the processor either the patch data from the patch data memory or the patch code instruction from the patch code memory depending on whether the processor is performing a code access or a data access to an address of the memory device being patched.

20. The computer system of claim 19 wherein the selection means includes a multiplexer having first and second data inputs coupled to the patch data memory and patch code memory, respectively, and a control input coupled to receive a control signal indicating whether the processor is performing a code access or a data access.
